(19) United States
(12) Patent Application Publication
(10) Pub. No.: US 2013/0231398 A1
(43) Pub. Date: Sep. 5, 2013

(54) CHABAZITE AND CLINOPTILOLITE IN OXYGEN ABSORBERS

(71) Applicants: Thomas H. Powers, Mayville, NY (US); David S. Payne, West Seneca, NY (US); John W. Crump, Buffalo, NY (US); George E. McKedy, Williamsville, NY (US)

(72) Inventors: Thomas H. Powers, Mayville, NY (US); David S. Payne, West Seneca, NY (US); John W. Crump, Buffalo, NY (US); George E. McKedy, Williamsville, NY (US)

(73) Assignee: Multisorb Technologies, Inc., Buffalo, NY (US)

(21) Appl. No.: 13/703,215

(22) PCT Filed: Jun. 10, 2011
(86) PCT No.: PCT/US11/39967

§ 371 Date: May 17, 2013

Related U.S. Application Data
(63) Continuation of application No. 12/813,433, filed on Jun. 10, 2010, now abandoned.
(60) Provisional application No. 61/415,169, filed on Nov. 18, 2010.

(51) Int. Cl. B01J 20/24; B01J 20/22

(52) U.S. Cl. CPC B01J 20/24; B01J 20/22
USPC 514/770; 252/194; 435/2; 426/322

(57) ABSTRACT

This invention relates generally to an oxygen absorber and more particularly, to oxygen absorbers including iron and one or more oxygen and water absorbing feldspars such as Chabazite and Clinoptilolite.

### CROSS-REFERENCE TO RELATED APPLICATIONS

The present application is a continuation-in-part of U.S. Non-Provisional patent application Ser. No. 12/813,433 filed Jun. 10, 2010 and U.S. Provisional Patent Application No. 61/415,169 filed Nov. 18, 2010, the entire disclosures of which are hereby expressly incorporated by reference.

### FIELD OF THE INVENTION

This invention relates generally to oxygen absorbers and more particularly, to oxygen absorbers including iron and one or more oxygen and water absorbing feldspars such as Chabazite and Clinoptilolite.

### BACKGROUND OF THE INVENTION

There has been wide use of oxygen absorbers in the area of packaged foods and over-the-counter medicines and pharmaceutical medicines. The use of oxygen absorbers leads to the longer shelf life of foods and medical products. These products have a tendency to decay or chemically react. These chemical reactions may decrease the efficiency of the medicine. The oxidation of food products causes them to lose flavor and in some cases become not edible.

The known commercial oxygen absorbers generally comprise iron, salt and some water in order to activate the iron. Other ingredients also may be utilized and are known for use in oxygen absorption such as activated carbon and special polymers that are activated by ultraviolet radiation.

Many of the existing oxygen absorbers or scavengers, particularly the iron-based absorbers utilized in food products such as meats and snacks have the undesirable effect that they will give off hydrogen as a byproduct of the absorption of the oxygen. While this is not normally a fire or health hazard it is undesirable in that the packaging will swell and the consumer will believe that the food product has begun to decay.

Further the oxygen absorbers containing activated iron or polymer materials that may be activated by ultraviolet radiation are expensive and there is a need for a lower-cost oxygen absorber. A lower-cost oxygen absorber would allow more materials to be economically packed with oxygen scavenger protection and allow lower food costs overall. Therefore, there is a desire for lower cost and food safe oxygen absorber.

### BRIEF SUMMARY OF THE INVENTION

This invention relates generally to an oxygen absorber including iron and a high chloride zeolite.

### DETAILED DESCRIPTION OF THE INVENTION

The present invention has numerous advantages over prior products. The invention provides a lower-cost oxygen absorber. The invention is desirable in that significant hydrogen is not given off during oxygen absorption. Further, significant heat is not generated during oxygen absorption. The invention oxygen absorber is lower in cost and safe for both food and pharmaceutical products. The invention material further absorbs water and will provide some dehydration of a product if needed as well as activating the iron. These and other advantages will be apparent from the detailed description below.

The combination of the invention zeolites with iron in an oxygen absorbing composition surprising results in very efficient oxygen absorption without the generation of significant hydrogen gas. The zeolites and activated iron particles are generally combined with activated carbon which apparently serves to act as a catalyst to aid in the generation of electrolyte material utilizing the zeolite as well as increasing the oxygen absorbent capacity of the composition. The composition generally contains a lubricant and mixing aid such as glycerin to aid in the mixing of the iron particles, zeolites and carbon. It is been found that the reaction to absorb oxygen is slower without the carbon present. A coconut shell activated carbon is preferred for its activity in catalyzing the oxygen absorption. The activated carbon also is capable of absorbing some oxygen.

Any natural or artificial zeolite or mixture of zeolites which provides the desired oxygen absorption is suitable for the invention. Zeolites that have the ability to absorb water in an amount of greater than 50% of their weight are preferred. It is further preferred that they have a significant halogen content of sodium and/or potassium. Typical of suitable zeolites are Erionite, Mordenite, and Philipsite. Preferred for the invention are Chabazite and Clinoptilolite or mixtures of these materials because these materials absorb greater than 50% by weight water and contain soluble halogens, particularly chloride. It is theorized that the reason hydrogen is not given off with the invention compositions is that the material in the zeolite such as sodium, potassium, and silica reacts to create hydroxides rather than releasing the hydrogen. It is also found that mixtures of two or more zeolites will still produce desirable results.

The primary oxygen scavenger may be any suitable metal material that is activated by water. Typically the oxygen scavenger would be a transition metal powder such as iron, zinc, manganese, copper, and others known from prior art. A preferred oxygen scavenger is reduced iron powder. The iron based oxygen scavenging materials can be any type used in the prior art including those described in U.S. Pat. No. 6,899,822; U.S. Patent Application Nos. 2005/0205841 and 2007/020456; all to Multisorb Technologies Inc., incorporated in their entirety by reference. The current invention is particularly focused on preferred iron-based powders with a mean particle size of 1-100 μm. The iron particles in one embodiment are mixed and/or pre-coated with activating and oxidation reaction promoter particles to form a homogeneous powder made up of heterogeneous particles. This way each particle contains all necessary components for efficient oxygen scavenging except water, carbon, and zeolite.

The types of iron that can be used are hydrogen reduced iron, especially sponge grade hydrogen reduced iron, annealed electrolytically reduced iron and carbonyl iron. The hydrogen reduced sponge grade iron is preferred because it has been found that it functions significantly better than other irons. It is believed that this better functioning is due to the fact that the sponge grade hydrogen reduced iron has a much larger surface area per unit weight because the surface is larger than the surface of annealed electrolytically reduced iron which is spherical. However, other types of iron including but not limited to non-annealed electrolytically reduced iron can also be used in addition to the various irons noted above.

The majority of the iron may have a size of between about 150 microns and 1 micron, and more preferably between about 100 microns and 5 microns, and most preferably between about 50 microns and 5 microns.

The sodium bisulfate may be present by weight in an amount of between about 1% and 30%, and more preferably between about 4% and 20%, and most preferably between about 5% and 18% of the iron by weight.

The majority of the sodium bisulfate may have a size of between about 150 microns and 1 micron, and more preferably between about 100 microns and 5 microns, and most preferably between about 50 microns and 5 microns. However, if desired, the sodium bisulfate or any other acidifier may be applied as a solution to the iron and the solvent can then be removed, leaving a deposit of the acidifier on the iron.

If sodium bisulfate is utilized, the preferred acidifier in the composition, potassium bisulfate has been found to function satisfactorily. Also, other acids and acid salts will function satisfactorily as the acidifier. These may include, without limitation, fumaric acid, sodium diacetate, citric acid and sodium salt of acetic acid. These other acidifiers may be of the same size ranges and be used in the relative proportions with respect to the sodium bisulfate, depending on their relative molecular weights and acidity.

Any suitable activated carbon may be utilized in the invention. Typically, the activated carbon would have an average particle size between 0.15 mm and 1.0 mm. A preferred size is between 0.15 mm and 0.5 mm. A more preferred size is between 0.15 mm and 0.25 mm for good water and gas absorption. Activated carbon is very porous and therefore has a very high surface area. Activated carbon is suitable in this invention both to hold water and to absorb odors from the packaged food products.

In a preferred method of forming of the oxygen absorber of the invention the materials are formed in two separate batches and then combined. They are mixed in one batch that may be called a solid mixture and another batch which may be called a liquid mixture. These two mixtures are combined with further mixing to create the invention oxygen absorber.

The solid mixture generally comprises between 5 and 50% by weight carbon, between 10 and 75% by weight of iron and between 5 to 60% by weight of zeolite. Usually the solid mixture also would contain a small amount of a lubricant or mixing aid such as glycerin in and amount of between 3 and 15% by weight. A preferred amount of these materials is between 10 and 30% carbon, between 45 and 55% iron, and between 20 and 30% zeolite to provide sufficient iron for oxygen absorption, sufficient zeolite for absorbing moisture and reacting to form hydroxides, and sufficient carbon for catalyzing the reaction and also absorbing water.

In the forming of the preferred liquid mixture, the sodium chloride is utilized in amount of between 10 and 20% to the form sufficient electrolyte, optionally potassium carbonate in an amount of between 1 and 4%, sodium or potassium thiosulfate in an amount 0.5% and 2%. Water will form the remainder of the liquid mixture. The thiosulfate is believed to provide some acidity and increase the speed of oxygen absorption.

The solid mixture and liquid mixture are combined with about 80% by weight solid mixture and about 20% of the liquid mixture.

The oxygen absorption composition of the invention may be utilized in a variety of ways. Generally the mixture of the liquid and solid components is carried out and then the materials are dried to form particles. These particles may be placed in a sachet or container that is permeable to water vapor and oxygen. The oxygen absorbing particles are brought into gaseous contact with the oxygen in the package. The sachet or container is then placed into a package of food or medicine. The oxygen absorption composition of the invention further may be utilized in treatment of blood so as to remove oxygen and increase storage time. The blood would pass through an oxygen permeable tube with the absorbent material adjacent to the tube. The particular oxygen scavenger (oxygen absorber) of the invention may also be combined with a polymer and cast into a sheet for use as an oxygen absorber or may be placed into a label in order to be fastened to a package for oxygen absorption. The utilization of such labels is known from U.S. Pat. No. 6,139,935-Cullen and U.S. Pat. No. 5,641,425-McKedy. The oxygen absorber if formed into a sheet may be utilized to form bags or wrappers for food or medicine. The sheet further may be cut into pieces and placed in packages, bottles, blister packs, or glued onto the inner surface of packages perhaps as a label.

### Example 1

In accordance with the invention, the following ingredients were used:
a) 250 pounds 100 mesh electrolytic iron;
b) Chabazite 267 pounds 50 mesh;
c) Activated Carbon: 133.6 pounds 50×200 mesh coconut shell; and
d) Glycerin: 30 pounds.

The ingredients are combined as follows:
a) Combine the iron, chabazite, glycerin, and carbon in the mixer which can be, for example, a Forberg 18 cubic foot, 1,080 pound mixer with an integral chopper; add the glycerin solution to the liquid feed tank and mix while adding liquid for eight minutes.
b) Then mix and chop for two minutes.

The resulting mixture is unloaded into four drums with double liners. The liners are secured with a twist-tie, the drums are closed, and the product is complete.

### Example 2

In accordance with another example of this invention, the following ingredients are combined as described below:
a) Sorbox 101 248.4 pounds reduced iron 100 mesh;
b) Sorbox 103 248.4 pounds reduced activated iron 100 mesh;
c) Chabazite 248.4 pounds 50 mesh; and
d) Activated carbon 248 pounds 50 mesh coconut shell; and
e) Klucel EF12 hydrotypropylcellulose mix 84.6 pounds is mixed with 160 pounds of water, 32 pounds of NaC1, 2 pounds KCO₃, and 2 pounds sodium bisulfate.

The process proceeds as follows:
a) Add the iron, chabazite, and carbon to a Forberg mixer mix for two minutes.
b) Add the Klucel EF12 electrolyte solution to the mixer liquid feed tank and simultaneously mix and add the liquid for twelve minutes.
c) Then scrape down the sides of the mixer and simultaneously mix and chop for two minutes. The finished mix should be unloaded into four drums with double liners. Secure the liners with twist-ties, close the drums and label the drums.

The mixed product is allowed rest for 24 hours before being used.

### Example 3

In accordance with another example of this invention, the following ingredients are combined as described below:
a) Sorbox 101 248.4 pounds reduced iron 100 mesh;
b) Sorbox 103 248.4 pounds reduced activated iron 100 mesh;
c) Chabazite 124.2 pounds 50 mesh;
d) Clinoptilolite 124.2 pounds 50 mesh; and
e) Activated carbon 248 pounds 50 mesh coconut shell; and
f) Klucel EF12 hydrotypropylcellulose mix 84.6 pounds is mixed with 160 pounds of water, 32 pounds of NaC1, 2 pounds KCO₃, and 2 pounds sodium bisulfate.

The process proceeds as follows:
a) Add the iron, chabazite, Clinoptilolite, and carbon to a Forberg mixer mix for two minutes.
b) Add the Klucel EF12 electrolyte solution to the mixer liquid feed tank and simultaneously mix and add the liquid for twelve minutes.
c) Then scrape down the sides of the mixer and simultaneously mix and chop for two minutes. The finished mix should be unloaded into four drums with double liners. Secure the liners with twist-ties, close the drums and label the drums.

The mixed product is allowed rest for 24 hours before being used.

### Example 4

Oxygen absorber is made using the same method as described in Example 1 except the formulation used is as follows:
a) 564 pounds of activated iron 100 mesh;
b) 11.6 pounds of electrolytic iron 100 mesh;
c) 247.2 pounds of Clinoptilolite 50 mesh;
d) 247.2 pounds of activated carbon 50 mesh coconut shell; and
e) 108 pounds of glycerine.

The Clinoptiolite was obtained from St. Cloud Mining Co., Winston, New Mexico, 87943.

Twelve representative sachets were taken from both runs of Clinoptiolite for testing. Six of these using Clinoptiolite from St. Cloud's St. Cloud mine, and Six using Clinoptiolite from St. Cloud's Ash Meadows mine. Each sachet was weighed, and placed in a 10000 cc polymer bag with high oxygen barrier properties, along with around 4 g of moisture on blotter paper. Each bag was then filled with a gas mixture containing 1% Oxygen. Each bag was tested initially to determine an initial Oxygen level and then were refrigerated at a temperature between 0-6 degrees Celcius. Oxygen level tests, using a standard Oxygen Analyzer with probe, was done at 6 hours from insertion of the sachet, 12 hours, and 24 hours. The results of the test are shown below. These tests show the oxygen absorption ability of the Clinoptiolite.

| | | | INITIAL | % O₂ | % O₂ | % O₂ | CONTAINER | CC's O₂ | CC's O₂ | CC's O₂ |
|---|---|---|---|---|---|---|---|---|---|---|
| | WEIGHT | Clinoptiolite | % O₂ | Level 6 | Level | Level | VOLUME | ABSORBED/ | ABSORBED/ | ABSORBED/ |
| Sample # | in grams | Type | Level | HR | 12 HR | 24 HR | IN CC | 6 HRS | 12 HRS | 24 HRS |
| 1A | 22.03 | Ash | 1.11 | 0.0116 | 0 | 0 | 10000 | 109.840 | 111.000 | 111.000 |
| | | Meadows | | | | | | | | |
| 2A | 21.91 | Ash | 0.965 | 0.0056 | 0 | 0 | 10000 | 95.940 | 96.500 | 96.500 |
| | | Meadows | | | | | | | | |
| 3A | 22.25 | Ash | 0.979 | 0.0094 | 0 | 0 | 10000 | 96.960 | 97.900 | 97.900 |
| | | Meadows | | | | | | | | |
| 4A | 21.29 | Ash | 1.02 | 0.0363 | 0.0093 | 0 | 10000 | 98.370 | 101.070 | 102.000 |
| | | Meadows | | | | | | | | |
| 5A | 21.42 | Ash | 1.12 | 0.0117 | 0 | 0 | 10000 | 110.830 | 112.000 | 112.000 |
| | | Meadows | | | | | | | | |
| 6A | 22.15 | Ash | 1.15 | 0.0078 | 0 | 0 | 10000 | 114.220 | 115.000 | 115.000 |
| | | Meadows | | | | | | | | |
| 1B | 21.85 | St. Cloud | 1.09 | 0.0345 | 0.0078 | 0 | 10000 | 105.550 | 108.220 | 109.000 |
| 2B | 22.26 | St. Cloud | 1.05 | 0.06 | 0.0088 | 0 | 10000 | 99.000 | 104.120 | 105.000 |
| 3B | 21.45 | St. Cloud | 1.12 | 0.0669 | 0.0086 | 0 | 10000 | 105.310 | 111.140 | 112.000 |
| 4B | 21.85 | St. Cloud | 1.06 | 0.0369 | 0.0105 | 0 | 10000 | 102.310 | 104.950 | 106.000 |
| 5B | 21.85 | St. Cloud | 1.12 | 0.0521 | 0.0087 | 0 | 10000 | 106.790 | 111.130 | 112.000 |
| 6B | 21.93 | St. Cloud | 1.09 | 0.103 | 0.0129 | 0 | 10000 | 98.700 | 107.710 | 109.000 |

In accordance with another aspect of this invention, the oxygen absorber is provided in vapor permeable, water impermeable spunbond polypropylene sachets. The sachets are prepared generally as follows: the dry mixture is prepared, water and the electrolyte are mixed together, and the dry oxygen absorber mixture and water/electrolyte mixtures are dispensed into a sachet and the sachet is sealed. The sachet is preferably placed in an oxygen impermeable container for storage prior to use.

The Applicant compared a chabazite based scavenger with a scavenger based on salt having a substantially equal amount of chloride and the chabazite sample performed significantly better. The Applicant believes that chabazite is acting as a catalyst for the iron reduction reaction. Clinoptilolite will act in a similar manner.

The catalytic effect of the carbon is dependent on the structure of the activated carbon and the surface area. A gram of activated carbon has the internal surface area of about 1,200 square meters per frame. The greater the internal surface area the greater the catalytic affect. Activated carbons with high internal surface area offer many sites for surface catalyzed reactions. The functional groups on the pore surface are believed to play an important role in the surface catalyzed reactions.

The Applicant believes that combination of iron with either the Clinoptilolite or chabazite zeolites, or activated carbon and zeolites provide enhanced results perhaps because the conductivity of the chabazite or Clinoptilolite and carbon is higher than other water carriers. Chabazite and Clinoptilolite contain many oxides such as potassium, sodium, calcium, and iron that are believed to produce many free ions in chabazite that are released in solution and give high conductivity. The following table compares the conductivity of chabazite with a number of other materials.

| | Conductivity | |
|---|---|---|
| | (μs/cm) | pH |
| Chabazite | 1491. | 9.231 |
| Distilled water | 6.98 | 6.677 |
| 4A Molecular sieve | 125.7 | 8.882 |
| Silica gel type B | 72.6 | .744 |
| Clay, Oklahoma wet | 19.2 | 7.984 |
| Activated carbon | | |
| 02-00503AH07 Calgon | 1235. | 10.217 |
| 02-02749AH01 Jacobi | 1546. | 10.037 |

The Applicant has found that oxygen absorbers made in accordance with this invention have the following benefits:
a) Binder with lower water content, reducing the chance of preactivation and overall lower water activity for the product;
b) Introduction of chabazite or Clinoptilolite, natural zeolites which is theorized to act as a catalyst to the oxygen absorption reaction through the presence of chloride ions at a concentration of 2;
c) The optional addition of a poly alcohol aids mixing conditions and facilitates the electrolytic reactions; and
d) The polyol also provides functionality at low temperatures, acting as an antifreeze, reducing the overall heat produced by the product as it begins to absorb.

Oxygen absorbers made in accordance with this invention provide increased rates of absorption for many food applications along with shorter lifetimes before the absorption commences. A disadvantage of known oxygen absorbers is their high cost and increase in production of hydrogen due to lack of oxygen for absorption and high pH during the exothermic oxygen forming reaction.

The Applicant believes that the present invention provides improved oxygen adsorption with enhanced electrolyte reactions and also shorter lag times before adsorption begins. The oxygen absorber of the invention does not become as hot as previously known absorbers when exposed to oxygen for an appreciable time.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. An oxygen absorber comprising:
(a) iron; and
(b) a high chloride zeolite.

2. The oxygen absorber of claim 1 wherein the zeolite is selected from the group consisting of Clinoptilolite and chabazite.

3. The oxygen absorber of claim 1 wherein the zeolite is a mixture of two or more zeolites.

4. The oxygen absorber of claim 1 further comprising glycerin.

5. The oxygen absorber of claim 4 further comprising activated carbon.

6. The oxygen absorber of claim 2 further comprising water.

7. The oxygen absorber of claim 6 in which the iron is selected from the group consisting of sponge iron, electrolytically reduced iron and annealed iron.

8. The oxygen absorber of claim 1 further comprising carbon.

9. The oxygen absorber of claim 7 in which the carbon comprises carbon derived from coconut.

10. The method of absorbing oxygen comprising bringing a material in a container into gaseous contact with an oxygen absorber comprising:
(a) iron; and
(b) a high chloride zeolite.

11. The method of claim 10 wherein the zeolite is selected from the group consisting of Clinoptilolite and chabazite.

12. The method of claim 10 wherein the zeolite is a mixture of two or more zeolites.

13. The method of claim 10 further comprising glycerin.

14. The method of claim 13 further comprising activated carbon.

15. The method of claim 11 further comprising water.

16. The method of claim 15 in which the iron is selected from the group consisting of sponge iron, electrolytically reduced iron and annealed iron.

17. The method of claim 10 further comprising carbon.

18. The method of claim 17 wherein the material is food and the container is a food package.

19. The method of claim 17 wherein the container is a tube and the material is human blood.

20. The method of claim 17 wherein the material is medicine and the container is a medicine package.
